(19) United States
(12) Patent Application Publication
(10) Pub. No.: US 2010/0109200 A1
(43) Pub. Date: May 6, 2010

(54) Thermoplastic Polyurethane Prepared Using A Mixture Of Polyester Diol And Poly(Propylene Oxide) Diol

(75) Inventors: John M. Cox, Lake Jackson, TX (US); Bowdie J. Isanhart, Coleman, MI (US); Mark F. Sonnenschein, Midland, MI (US); Rogert P. Clement, Midland, MI (US)

Correspondence Address: LEGAL DEPARTMENT;LUBRIZOL ADVANCED MATERIALS, INC, 9911 BRECKSVILLE ROAD, CLEVELAND, OH, 44141-3247, US

(73) Assignee: Lubrizol Advanced Materials, Inc., Cleveland, OH (US)

(21) Appl. No.: 12/593,329

(22) PCT Filed: Mar. 21, 2008
(86) PCT No.: PCT/US2008/057773

§ 371 Date: Dec. 3, 2009

Related U.S. Application Data
(60) Provisional application No. 60/920,628, filed on Mar. 29, 2007.

(51) Int. Cl. B29C 41/42; C08G 18/66

(52) U.S. Cl. 264/334; 528/76

(57) ABSTRACT

The present invention is a low haze thermoplastic polyurethane (TPU) elastomer prepared from a diol mixture that includes a polyester diol and a difunctional homopolymer of propylene oxide. The TPU elastomers of the invention solidify quickly in injection molding processes, thus reducing cycle time and manufacturing costs.

This application claims benefit from U.S. Provisional Application 60/920,628, filed 29 Mar. 2008.

This invention relates to thermoplastic polyurethanes.

Thermoplastic polyurethane (“TPU”) elastomers are used in a variety of applications such as gears, bearings, joints for precision machinery, parts for electronic instruments, soles, bladders and uppers for athletic shoes and ski boots, automotive parts, seals, gaskets and packings for hydraulic fluid systems, as well as other applications. TPU elastomers are typically the reaction product of one or more diisocyanate compounds, one or more high equivalent weight diols and one or more chain extenders.

For many applications, the high equivalent weight diol of choice is a polyester diol, such as an adipate polyester or polycaprolactone. The polyester diols impart certain desirable mechanical properties to the TPU elastomer. Polyester diols also contribute to abrasion resistance, which makes the TPU elastomer useful in footwear applications and others in which resistance to abrasion is an important attribute. However, cycle times sometimes are longer than desirable when soft to moderately hard (Shore hardness from 60 on the A scale to about 75 on the D scale) polyester-based TPU elastomers are melt-processed. The longer cycle times reduce the productivity of manufacturing equipment and in that way increase costs.

In some cases, mixtures of a polyester polyol with various types of polyether polyols have been used to make TPU elastomers. Thus, for example, U.S. Pat. No. 4,980,445 describes using a mixture of a polyester diol and up to 14 mole % of a polyether diol. Various types of polyether diols are described, with the poly(tetramethylene oxide) types said to be the most preferred. U.S. Pat. No. 4,124,572 describes a mixture of a polyester diol and a propylene oxide-ethylene oxide copolymer containing 25 to 60% by weight of polymerized ethylene oxide. Other types of polyol mixtures for use in making TPU elastomers are described, for example, in U.S. Pat. No. 5,648,447 (poly(tetramethylene oxide) with poly(propylene oxide) or poly(ethylene oxide)) and U.S. Pat. No. 5,013,811 (mixture of a polycarbonate diol and a poly(tetramethylene oxide) diol).

It would be desirable to provide a TPU elastomer that is economical, exhibits good physical properties, especially good abrasion resistance, and which can be melt processed with short cycle times. The hardness of the TPU elastomer suitably is between a Shore A durometer hardness of 60 and a Shore D durometer hardness of 75.

This invention is a thermoplastic polyurethane (TPU) elastomer which is a polymer of (1) a mixture of at least one high equivalent weight polyester diol and at least one difunctional, high equivalent weight homopolymer of propylene oxide, (2) at least one chain extender and (3) at least one diisocyanate.

In another embodiment, the invention is a TPU elastomer which is a polymer of (1) a mixture containing from 20 to 80% by weight of at least one high equivalent weight poly(caprolactone) diol and from 80 to 20% by weight of at least one high equivalent weight poly(propylene oxide) diol, (2) 1,4-butanediol or mixture thereof with at least one other chain extender mixture, and (3) at least one diisocyanate.

The invention is also a process comprising forming a melt of a thermoplastic polyurethane, injecting the melt into a mold, allowing the thermoplastic polyurethane to solidify within the mold to form a molded part, and then demolding the molded part, wherein the thermoplastic polyurethane is the thermoplastic polyurethane as described in either of the preceding two paragraphs.

The TPU elastomers of the invention exhibit good physical properties, and in particular have good abrasion resistance, as measured in accordance with DIN 53516-10N/40 m or ASTM D1044 H-22.

As used herein, the term “thermoplastic polyurethane” or “TPU” in intended as a shorthand to include materials having urethane groups (as are formed in the reaction of hydroxyl-containing compounds with isocyanate-containing compounds) as well as materials having both urethane and urea groups (as are formed in the reaction of isocyanate-containing compounds with both hydroxyl-containing compounds and compounds that contain primary or secondary amino groups).

The TPU elastomer of the invention is prepared using a mixture of at least two high equivalent weight difunctional compounds. In this invention, the high equivalent weight difunctional compounds include at least one polyester diol and at least one difunctional homopolymer of propylene oxide. The polyester diol or diols constitute from 20 to 80%, preferably from 40 to 80%, by weight of the high equivalent weight difunctional compounds. The difunctional propylene oxide homopolymer(s) constitute from 80 to 20%, preferably from 60 to 20%, by weight of the high equivalent weight difunctional compounds.

For purposes of this invention, a “high equivalent weight difunctional compound” is a material having nominally 2.0 isocyanate-reactive groups per molecule and an equivalent weight per isocyanate-reactive group of at least 300. The isocyanate-reactive groups may be, for example, hydroxyl, primary amino, secondary amino or thiol groups. The high equivalent weight isocyanate-reactive groups are preferably aliphatic hydroxyl groups. The hydroxyl equivalent weight preferably is from 500 to 2000 and more preferably from 700 to 1200.

Suitable polyester diols include aliphatic polyesters and aromatic polyesters. Aliphatic polyesters include polymers and copolymers of one or more cyclic lactones (such as caprolactone); polymers and copolymers of hydroxyalkanoic acids such as lactic acid, 3-hydroxyproprionic acid or glycolic acid (or cyclic dianhydride dimers thereof such as lactide or glycolide); and A-B type polyesters that correspond to the reaction product of one or more glycols with one or more aliphatic dicarboxylic acids. Aromatic polyesters are generally A-B type polyesters that correspond to the reaction product of at least one glycol with at least one aromatic carboxylic acid. By “corresponding to the reaction product of at least one glycol and at least one (aliphatic or aliphatic) dicarboxylic acid”, it is meant that the polyester contains repeating units corresponding to the structure of each glycol (after removal of each hydroxyl hydrogen) and repeating units corresponding to the structure of the dicarboxylic acid(s) (after removal of the —OH group from each carboxylic acid group). This term in not intended to limit the polyester to those made in any particular way. As discussed below, various synthetic schemes can be used to make an A-B type polyester. By “glycol”, it is meant a compound having exactly two hydroxyl groups/molecule and a molecular weight of up to 300, preferably up to 200 and more preferably up to 100. A-B type polyesters can be made with small amounts of branching agents (typically polyols having 3 or more hydroxyl groups/molecule), although such branching agents should be used in small proportions.

Examples of useful aliphatic A-B type polyesters include those corresponding to the reaction product of a glycol such as 1,4-butanediol, hydroquinone bis(2-hydroxyethyl)ether, ethylene glycol, diethylene glycol, triethylene glycol, propylene glycol, dipropylene glycol, tripropylene glycol, 2-methyl-2-ethyl-1,3 propanediol, 2-ethyl-1,3-hexanediol, 1,5-pentanediol, thiodiglycol, 1,3-propanediol, 1,3-butanediol, 2,3-butanediol, neopentyl glycol, 1,2-dimethyl-1,2-cyclopentanediol, 1,6-hexanediol, 1,2-cyclohexanediol, 1,2-dimethyl-1,2-cyclohexanediol, and the like, with a dicarboxylic acid such as adipic acid, succinic acid, glutaric acid, azelaic acid, sebacic acid, malonic acid, maleic acid or fumaric acid. Of these aliphatic A-B type polyesters, those based on adipic acid, such as poly(propylene adipate), poly(butylene adipate) and poly(ethylene adipate) are particularly preferred. Suitable commercially available grades of adipate polyesters include those sold by Crompton Chemicals under the trade names Fomrez 44-56 and Fomrez 44-57.

Examples of useful aromatic A-B type polyesters include those corresponding to the reaction product of a glycol such as 1,4-butanediol, hydroquinone bis(2-hydroxyethyl)ether, ethylene glycol, diethylene glycol, triethylene glycol, propylene glycol, dipropylene glycol, tripropylene glycol, 2-methyl-2-ethyl-1,3 propanediol, 2-ethyl-1,3-hexanediol, 1,5-pentanediol, thiodiglycol, 1,3-propanediol, 1,3-butanediol, 2,3-butanediol, neopentyl glycol, 1,2-dimethyl-1,2-cyclopentanediol, 1,6-hexanediol, 1,2-cyclohexanediol, 1,2-dimethyl-1,2-cyclohexanediol, and the like, with an aromatic dicarboxylic acids such as phthalic acid, isophthalic acid, terephthalic acid, tetrachlotophthalic acid and chlorendic acid. Polymers of isophthalic acid or terephthalic acid with ethylene glycol, diethylene glycol, propylene glycol and 1,4-butanediol are preferred types of A-B aromatic polyesters.

Various reaction schemes can be used to form A-B type polyesters. One or more diacids as described above can be reacted directly with one or more glycols as described above to make the polyester. Alternatively, anhydrides, dialkyl esters and acid halides of the aforementioned dicarboxylic acids may be used as raw materials in the polymerization reaction, instead of or in addition to the dicarboxylic acid itself. It is also possible in some cases to form cyclic oligomers of the glycol(s) and the dicarboxylic acid(s) (or corresponding dialkyl ester(s) or anhydride(s)) and to polymerize the cyclic oligomer to form the polyester. Cyclic oligomers can be prepared by forming a low molecular weight polymer from the polyol(s) and dicarboxylic acid(s) (or corresponding dialkyl ester(s) or anhydride(s)), and depolymerizing the low molecular weight polymer to form the cyclic oligomer(s). The cyclic oligomers may be a cyclic reaction product corresponding to that of one polyol molecule and one dicarboxylic acid molecule, or may be have a higher degree of polymerization.

An especially preferred polyester is a polycaprolactone. Polycaprolactones are readily commercially available.

The homopolymer of propylene oxide is conveniently prepared by adding propylene oxide onto a difunctional initiator compound. The initiator compound should not be a poly(ethylene glycol) or poly(ethylene oxide), but may be, for example, ethylene glycol, propylene glycol, dipropylene glycol, tripropylene glycol, a poly(propylene oxide) diol of up to about 400 molecular weight, and the like.

Some commercially available polymers of propylene oxide tend to contain a certain amount of monofunctional impurities, and as such tend to have actual hydroxyl functionalities which are somewhat less than 2.0, such as from 1.6 to 1.99. These commercially available poly(propylene oxide)s are suitable for use herein, and are considered to be difunctional for purposes of this invention, based on their nominal functionality of 2.0. In such a case, it is also within the scope of the invention to mix the difunctional propylene oxide homopolymer with another high equivalent weight propylene oxide homopolymer having a higher nominal functionality, particularly one having a nominal functionality of 3.0. If desired, the relative proportions of the difunctional and higher functionality poly(propylene oxide)s can be selected so that the average actual functionality of the mixture is close to 2.0, such as from 1.9 to 2.2 or from 1.9 to 2.05.

Similarly, it is within the scope of the invention to use one or more propylene oxide homopolymers which have low levels of monofunctional impurities. The monofunctional impurities usually have unsaturated terminal groups. Therefore, the level of monofunctional impurities in a poly(propylene oxide) can be expressed in terms of the amount of that terminal unsaturation. If desired, the propylene oxide homopolymers(s) can have no more than 0.02 millequivalents of terminal unsaturation per gram. The amount of terminal unsaturation per gram can be no more than 0.01 or from 0.002 to 0.008 meq/g. Propylene oxide homopolymers having such low levels of unsaturation can be prepared using a variety of well-known double metal cyanide catalyst (DMC) complexes.

The chain extender used in the present invention is one or more materials that have 2 isocyanate groups/molecule and has a molecular weight of up to about 400 and preferably up to about 250. Diamine and diol chain extenders, especially diol chain extenders, are preferred. The chain extenders can be cyclic or non-cyclic materials. Cyclic chain extenders may be aromatic or non-aromatic. Examples of suitable chain extenders include, for example, ethylene glycol, diethylene glycol, 1,3-propanediol, dipropylene glycol, tripropylene glycol, 1,4-butanediol, 1,6-hexanediol, 1,5-heptane diol, ethylene diamine, 2-methyl-1,5-pentanediamine, 1,6-hexanediamine, isophorone diamine, piperazine, aminoethylpiperazine, methylene bis(aniline), diethyltoluenediamine, hydroquinone bis(2-hydroxyethylether), ethoxylated bisphenols, 1,4-cyclohexanedimethanol, 1,3-cyclohexanedimethanol, and the like. 1,3-cyclohexanedimethanol and 1,4-cyclohexanedimethanol each can be present as the cis-isomer, the trans-isomer, or a mixture of both cis- and trans-isomers. A cyclohexanedimethanol mixture may contain all four of cis-1,3-cyclohexanedimethanol, trans-1,4-cyclohexanedimethanol, cis-1,4-cyclohexandimethanol and trans-1,4-cyclohexane dimethanol, in which the 1,3-isomers constitute from 40 to 60% by weight of the mixture and the 1,4-isomers constitute from about 60 to 40% by weight of the mixture.

Mixtures of two or more of the foregoing chain extenders can be used. 1,4-butanediol and chain extender mixtures containing at least 50 mole-% 1,4-butanediol are most preferred among these.

Diisocyanates suitable for use in preparing a TPU elastomer according to this invention are well known in the art and include aromatic, aliphatic, and cycloaliphatic diisocyanates and combinations thereof. Representative examples of these diisocyanates can be found in U.S. Pat. Nos. 4,385,133, 4,522,975, and 5,167,899, which teachings are incorporated herein by reference. Preferred diisocyanates include 4,4′-diisocyanatodiphenylmethane (4,4′-MDI), 2,4′-diisocyanatodiphenylmethane (2,4′-MDI), p-phenylene diisocyanate, 1,3-bis(isocyanatomethyl)-cyclohexane, 1,4-diisocyanato-cyclohexane, hexamethylene diisocyanate, isophorone diisocyanate, 1,5-naphthalene diisocyanate, 3,3′-dimethyl-4,4′-biphenyl diisocyanate, 4,4′-diisocyanato-dicyclohexylmethane, 2,6-toluene diisocyanate and 2,4-toluene diisocyanate. More preferred are 4,4′-diisocyanato-dicyclohexylmethane and 4,4′-diisocyanatodiphenylmethane. Most preferred is 4,4′-MDI.

In addition to the foregoing materials, a small quantity of crosslinkers may be used in making the TPU elastomer. These materials can be used in amounts that do not result in the formation of gels during initial polymerization or subsequent melt processing operations. Crosslinkers are materials having three or more isocyanate-reactive groups per molecule and an equivalent weight per isocyanate-reactive group of less than 300, preferably less than 200 and especially from 30 to 150. Examples of crosslinkers include glycerine, trimethylolpropane, pentaerythritol, tetraethylene triamine, sorbitol, glucose, triethanolamine, diethanolamine, triisopropanolamine, diisopropanolamine, alkoxylated derivatives of any of the foregoing, and the like.

In addition, small amounts of one or more high equivalent weight materials having 3 or more isocyanate-reactive groups can be used to make the TPU elastomer. As discussed before, these may be added in some embodiments to compensate for monofunctional impurities that are present in some poly(propylene oxide) diols. They may also be used modify the rheological properties of the molten TPU elastomer or for other purposes related to processing. These materials can be used in amounts that do not result in the formation of gels during initial polymerization or subsequent melt processing operations. It is preferred to omit these materials.

The ratios of the foregoing components are selected together to form a polymer which is both thermoplastic and elastomeric. Soft to moderately hard elastomers are preferred. TPU elastomers can be characterized by their Shore durometer hardness. The TPU elastomer suitably has a Shore A durometer hardness of at least 60. The TPU elastomer may have a Shore D durometer hardness of up to 75 or even higher. The Shore A durometer hardness of the TPU elastomer is for some applications preferably at least 75 and more preferably at least 80. For some applications, the Shore A durometer hardness is preferred to be not greater than 100 and more preferred to be not greater than 95.

The hardness of the TPU elastomer is usually related to its “hard segment” content. “Hard segment” content refers to the proportion of the TPU elastomer that is made up of polymerized isocyanates, chain extenders and any crosslinkers that may be present. The TPU elastomer generally has a Shore A hardness as described before when the hard segment content is from about 20 to about 80% of the total weight of the TPU elastomer (not counting additives that do not form part of the polyurethane polymer). That is,

$$20 \% \leq \frac{100 \% \times ( {W}_{CE} + {W}_{I} + {W}_{XL} )}{{W}_{CE} + {W}_{I} + {W}_{XL} + {W}_{HEW}} \leq 80 \%$$

where W_{CE} is the combined weight of all chain extender, W_{I} is the combined weight of all isocyanate compounds, W_{XL} is the combined weight of all crosslinkers (if any) and W_{HEW} is the combined weight of all high (≧300) equivalent weight isocyanate-reactive materials. Preferably, the hard segment content is from 30 to 70% by weight. An especially preferred hard segment is from 35 to 55% by weight. An advantage of this invention is that good optical clarity can be obtained even in elastomers having somewhat high hard segment contents, such as above 35% by weight.

The soft segment content corresponds to the proportion of high equivalent weight isocyanate-reactive materials used to make the TPU elastomer, and equals 100% minus the hard segment content. The soft segment content is therefore generally from 20 to 80% by weight, preferably from 30 to 70% by weight and more preferably from 45 to 65% by weight.

The isocyanate index is the ratio of equivalents of isocyanate groups per equivalent of isocyanate-reactive groups in the reactive mixture used to make the TPU elastomer. This isocyanate index is preferably from 0.95 to 1.20. It is more preferably up to and including about 1.08, still more preferably up to and including about 1.05, and even more preferably up to and including about 1.01.

The TPU elastomer of the invention is conveniently prepared by forming a reaction mixture containing the high equivalent weight difunctional polyester polyol, the high equivalent weight homopolymer of propylene oxide, the chain extender(s), and the diisocyanate (and optional reactive components as described before), and subjecting the mixture to conditions such that they react to form a high equivalent weight, thermoplastic polymer. Conditions for the reaction of such starting materials are well known and described, for example, in U.S. Pat. Nos. 3,214,411, 4,371,684, 4,980,445, 5,013,811, 5,648,447, 6,521,164 and 7,045,650. The reaction conditions include the application of heat to drive the polymerization reaction, and may include the presence of a polymerization catalyst. The materials may be heated separately before bringing them together to react to form the TPU elastomer. The starting materials are preferably reacted in the substantial absence of water, as water will react with the diisocyanate to form polyurea linkages and generate carbon dioxide.

If desired, the polymerization may be conducted in stages by first reacting the diisocyanate with all or a portion of the chain extender mixture or the high equivalent weight difunctional compound(s) to form a prepolymer. The prepolymer is then caused to react with the remainder of the isocyanate-reactive materials to advance the prepolymer and form the TPU elastomer.

The polymerization is preferably performed in a reactive extrusion process. In such a process, the starting materials are charged into an extrusion device (such as a single-screw or twin-screw extruder), which is heated to the polymerization temperature. The starting materials may be preheated to the polymerization temperature prior to charging them into the apparatus. The reaction mixture then passes through a heated zone where the polymerization takes place. The molten polymer is then extruded through a die. In most cases, it will be cooled and formed into flakes or pellets for use in subsequent melt processing operations, although it is possible to perform the melt processing operation in combination with the polymerization reaction.

Various types of optional components can be present during the polymerization reaction, and/or incorporated into the TPU elastomer.

It is usually preferable to incorporate one or more antioxidants into the TPU elastomer. These may be added during the polymerization reaction, or blended into the previously-formed polymer. Suitable antioxidants include phenolic types, organic phosphites, phosphines and phosphonites, hindered amines, organic amines, organo sulfur compounds, lactones and hydroxylamine compounds. For applications in which transparency is wanted, the antioxidant is preferably soluble in the TPU elastomer, or dispersable therein as very fine droplets or particles. Many suitable antioxidant materials are available commercially. These include Irganox™ 1010, Irganox™ MD1024, Irgaphos™168, Irgphos™126, all available from Ciba Specialties, and the like.

A UV stabilizer is another preferred additive, particularly in applications in which transparency is wanted or in which the part will be exposed to sunlight or other sources of ultraviolet radiation. UV stabilizers include substituted benzophenones, benzotriazoles and benzoxazinones, substituted triazines, hindered amines as well as diphenyl acrylate types. These materials are available commercially from Cytek Industries, Ciba Giegy and BASF, among other suppliers.

One or more polymerization catalysts may be present during the polymerization reaction. Catalysts for the reaction of a polyisocyanate with polyol and polyamine compounds are well known, and include tertiary amines, tertiary phosphines, various metal chelates, acid metal salts, strong bases, various metal alcoholates and phenolates and metal salts of organic acids. Catalysts of most importance are the tertiary amines and organotin catalysts. It is often preferred to omit such catalysts, for at least two reasons. First, they often tend to catalyze depolymerization reactions when the TPU elastomer is melt-processed, leading to a degradation of the polymer and loss of properties. Second, catalyst residues can impart unwanted color to the TPU elastomer.

Fillers and reinforcing agents can be incorporated into the TPU elastomer, but these are preferably omitted when a transparent part is wanted. Fillers include a wide range of particulate materials, including talc, mica, montmorillonite, marble, granite, milled glass, calcium carbonate, aluminum trihydrate, carbon, aramid, silica, silica-alumina, zirconia, talc, bentonite, antimony trioxide, kaolin, coal-based fly ash, boron nitride and various reclaimed and reground thermoset polyurethane and/or polyurea polymers. Reinforcements include high aspect ratio materials such as platelets and fibers, which can be of glass, carbon, aramid, various other polymers, and the like.

Other optional additives include slip additives, mold release agents, plasticizers, rheology modifiers, colorants, biocides, and the like.

The TPU elastomer of the invention is useful in a wide range of applications. It can be melt processed in a number of ways to form shaped articles such as coatings, films, sealants, gears, bearings, joints for precision machinery, parts for electronic instruments, soles, bladders and uppers for athletic shoes and ski boots, automotive parts, seals, gaskets and packings for hydraulic fluid systems, hose jacketing, tubing, castor wheels, as a barrier layer for hospital gowns as well as many other parts.

The melt-processing step can be performed as part of the overall polymerization process. In such a case, the polymerized reaction mixture is transferred, without cooling below its solidification temperature, to a downstream operation in which it is formed into a desired product. The downstream operation may be, for example, an extrusion step, a melt-casting step, a stamping step, an injection molding step, or other type of molding operation.

However, it is more typical to cool the polymerized TPU elastomer to form solid particles and to perform the melt processing step separately.

An advantage of this invention is that, in certain melt processing operations, reduced cycle times can be achieved, relative to those seen with TPU elastomers that use only the polyester diol. This is believed to be due to faster phase segregation, followed by crystallization of the TPU as it is cooled. This causes the molten TPU to solidify more rapidly. In molding processes, faster solidification means that the part does not need to remain in the mold for as long. The shorter in-mold residence time that is required can reduce the overall cycle time of the molding process.

The following examples are for illustrative purposes only and are not intended to limit the scope of this invention. All parts and percentages are by weight unless otherwise indicated.

### EXAMPLE 1 AND COMPARATIVE SAMPLE A

TPU elastomer Example 1 and Comparative Sample A are prepared from the formulations described in Table 1. The components are dried and directly injected into the feed throat of a twin screw extruder and allowed to fully react at temperatures up to 220° C. The extrudate is passed through a die and subsequently cut under water to form pellets. The water is removed from the pellets using a spin dryer. The pellets are then transferred to a desiccant dryer at 80° C. and dried. TPU Elastomer Example 1 is melted in an extruder having zones heated to 226° C., 210° C., 210° C., 201° C. and 193° C., and injected into plaque molds that are 3.125 mm thick by 125.7 cm wide by 125.7 cm long. Injection pressure is 1034 psi (˜7.1 MPa) and hold pressure is 800 psi (˜5.5 MPa). The mold is maintained at 38° C. and equipped with a pressure transducer near the gate end. The pressure transducer measures pressure exerted by the elastomer composition as it is injected and solidifies. Solidification results in a slight shrinkage of the part, which is evidenced by a drop in pressure seen by the transducer. The time in seconds after injecting the TPU elastomer until the pressure drop is seen by the transducer is taken as representative of the time required for TPU Elastomer Example 1 to solidify and become ready for demold. Results are as indicated in Table 1.

Pellets of TPU Elastomer Comparative Sample A are polymerized, prepared and molded in the same manner, except that extruder zone temperatures are 218° C., 196° C., 193° C., 188° C. and 182° C. The lower temperatures are used in an attempt to duplicate the injection pressure and hold pressure used in Example 1. Actual injection pressure is 1080 psi (˜7.4 MPa) and hold pressure is 750 psi (˜5.2 MPa). A second molding is performed at the same extruder temperatures used to mold TPU elastomer Example 1. Results are as in Table 1 below.

TABLE 1

Parts by Weight

| Raw Material | Ex. 1 | Comp. Sample A |
|---|---|---|
| Polyester diol¹ | 27.1 | 54.2 |
| Polyether diol² | 27.1 | 0 |
| 1,4-butanediol | 10 | 10 |
| 4,4′-MDI | 35.4 | 35.4 |
| Additive Package³ | 1.05 | 1.05 |
| Organotin catalyst | 0.02 | 0.02 |
| % Hard Segment | 45.4 | 45.4 |
| Solidification time, s | 10 | 16/14⁴ |

¹A 2000 molecular weight polycaprolone diol.
²A nominally difunctional poly(propylene oxide) homopolymer having a molecular weight of 2000.
³A mixture of a slip agent, one or more antioxidants and one or more UV stabilizers.
⁴16 seconds at approximately equal molding pressures as used in Example 1, 14 seconds at heating conditions equivalent to those used in Example 1.

The results in Table 1 show that the presence of the poly(propylene oxide) homopolymer results in faster solidification of the injection molded part, which leads directly to a shorter cycle time for the injection molding process.

1. A thermoplastic polyurethane elastomer which is a polymer of (1) a mixture of at least one high equivalent weight polyester diol and at least one difunctional high equivalent weight homopolymer of propylene oxide, (2) at least one chain extender and (3) at least one diisocyanate.

2. The thermoplastic polyurethane elastomer of claim 1, wherein the polyester diol and the difunctional high equivalent weight homopolymer of propylene oxide each has an equivalent weight of from about 500 to 2000.

3. The thermoplastic polyurethane elastomer of claim 2, wherein the polyester diol is an aliphatic polyester diol.

4. The thermoplastic polyurethane elastomer of claim 3, wherein at least 50 weight percent of the chain extender is 1,4-butanediol.

5. The thermoplastic polyurethane elastomer of claim 4, wherein the diisocyanate is 4,4′-MDI.

6. The thermoplastic polyurethane elastomer of claim 5, which has a Shore A durometer hardness of at least 60 and a Shore D durometer hardness of up to 75.

7. The thermoplastic polyurethane elastomer of claim 6, which has a hard segment content is from 35 to 55% by weight.

8. The thermoplastic polyurethane elastomer of claim 7, wherein the polyester diol and the difunctional high equivalent weight homopolymer of propylene oxide each has an equivalent weight of from about 700 to 1200.

9. The thermoplastic polyurethane elastomer of claim 8, wherein the polyester diol is polycaprolactone.

10. The thermoplastic polyurethane elastomer of claim 1, which is in the form of an injection molded article.

11. The thermoplastic polyurethane elastomer of claim 4, which is in the form of an injection molded article.

12. The thermoplastic polyurethane elastomer of claim 9, which is in the form of an injection molded article.

13. A thermoplastic polyurethane elastomer which is a polymer of (1) a mixture containing from 20 to 80% by weight of at least one high equivalent weight poly(caprolactone) diol and from 80 to 20% by weight of at least one difunctional high equivalent weight homopolymer of propylene oxide, (2) 1,4-butane diol or mixture thereof with at least one other chain extender mixture, and (3) at least one diisocyanate.

14. The thermoplastic polyurethane elastomer of claim 13, which has a Shore A durometer hardness of at least 60 and a Shore D durometer hardness of up to 75.

15. The thermoplastic polyurethane elastomer of claim 14, which is in the form of an injection molded article.

16. A process comprising forming a melt of a thermoplastic polyurethane, injecting the melt into a mold, allowing the thermoplastic polyurethane to solidify within the mold to form a molded part, and then demolding the molded part, wherein the thermoplastic polyurethane is the thermoplastic polyurethane of claim 1.

17. A process comprising forming a melt of a thermoplastic polyurethane, injecting the melt into a mold, allowing the thermoplastic polyurethane to solidify within the mold to form a molded part, and then demolding the molded part, wherein the thermoplastic polyurethane is the thermoplastic polyurethane of claim 13.
